(19) United States
(12) Patent Application Publication
(10) Pub. No.: US 2022/0197928 A1
(43) Pub. Date: Jun. 23, 2022

(54) MATCHING INFORMATION PROVIDING METHOD AND MATCHING INFORMATION PROVIDING PROGRAM

(71) Applicant: TOYOTA JIDOSHA KABUSHIKI KAISHA, Toyota-shi (JP)

(72) Inventors: Ayaka KAGAMI, Inazawa-shi (JP); Atsushi HANAWA, Miyoshi-shi (JP); Soshiro MURATA, Nagoya-shi (JP); Hideo HASEGAWA, Nagoya-shi (JP); Genshi KUNO, Kasugai-shi (JP); Yuta KIKUZAKI, Chiyoda-ku (JP); Yuu OOMI, Chiyoda-ku (JP); Takeshi YAMADA, Anjo-shi (JP); Masako FURUTA, Kariya-shi (JP); Toshihisa SHIMOME, Gifu-shi (JP); Kensuke SASAKI, Tokyo (JP)

(73) Assignee: TOYOTA JIDOSHA KABUSHIKI KAISHA, Toyota-shi (JP)

(21) Appl. No.: 17/493,367

(22) Filed: Oct. 4, 2021

(30) Foreign Application Priority Data
Dec. 17, 2020 (JP) 2020-208926

(51) Int. Cl. G06F 16/28

(52) U.S. Cl. CPC G06F 16/285

(57) ABSTRACT

Costume information regarding a costume that a plurality of users wants to wear at a destination is acquired. The plurality of users wishes to visit the destination. Users who are determined to match are grouped, based on the costume information of the plurality of users. At least one user, out of the grouped users, is provided with information on another user of the grouped users.

### CROSS-REFERENCE TO RELATED APPLICATION

This application claims priority to Japanese Patent Application No. 2020-208926 filed on Dec. 17, 2020, incorporated herein by reference in its entirety.

### BACKGROUND

### 1. Technical Field

The present disclosure relates to a matching information providing method and a matching information providing program for making a proposal about a person who becomes an accompanying person at a destination.

### 2. Description of Related Art

Japanese Unexamined Patent Application Publication No. 2016-076078 (JP 2016-076078 A) describes a technique in which prior to an event, a user sends his/her profile and information on desired conditions for his/her counterpart to a management server, and the management server provides information of other users that match the wish of the user in an area in which the event is held.

### SUMMARY

In JP 2016-076078 A, it is necessary to set the desired conditions by using specific words or selecting items presented in advance. Therefore, it is likely that one's wishes cannot be fully expressed, and therefore, the accuracy of matching tends to be low.

The present disclosure relates to a matching information providing method for making a proposal about an accompanying person at a destination. The matching information providing method includes: acquiring costume information regarding a costume that a plurality of users wants to wear at the destination, the plurality of users wishing to visit the destination; grouping users who are determined to match, based on the costume information of the plurality of users; and providing at least one user, out of the grouped users, with information on another user of the grouped users.

A person wishing to visit may download a costume application from an application providing site, the costume application allowing selection of the costume the person wants to wear, and when the costume is selected using the costume application, grouping may be performed based on the selected costume.

Current location information for the plurality of users may be acquired, and information on the other user of the grouped users may be provided for the plurality of users at the destination, the plurality of users being grasped based on the acquired current location information.

The plurality of users may be able to input visit information including a desired date and time of visiting the destination, and the visit information may be provided to another user of users grouped by the visit information.

The costume is a costume for a character related to the destination.

The present disclosure relates to a matching information providing program for making a proposal about an accompanying person at a destination. The matching information providing program causes a computer to: acquire costume information regarding a costume that a plurality of users wants to wear at the destination, the plurality of users wishing to visit the destination; group users who are determined to match, based on the costume information of the plurality of users; and provide at least one user, out of the grouped users, with information on another user of the grouped users.

According to the present disclosure, matching is performed through the selection of the costume that the user wants to wear. Therefore, the selection is concrete and easy, and the accuracy of matching can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing an example of a system that implements a matching information providing method according to the embodiment;

FIG. 2 is a block diagram showing a schematic configuration of a mobile terminal 10;

FIG. 3 is a flowchart illustrating user registration;

FIG. 4 is a flowchart illustrating costume selection by a user;

FIG. 5 is a diagram showing a state of user registration for each costume;

FIG. 6 is a flowchart showing a process of invitation to go together based on a matching result for a visiting user; and

FIG. 7 is a flowchart showing a process of invitation to go together based on a matching result for a user who wishes to visit.

### DETAILED DESCRIPTION OF EMBODIMENTS

Hereinafter, an embodiment of the present disclosure will be described with reference to the drawings. The present disclosure is not limited to the embodiment described below.

### Outline of Embodiment

In the embodiment, entertainment facilities that visitors enjoy based on a specific theme (concept) are focused as a destination to visit. In such entertainment facilities, the culture of a specific country, stories, movies, and the like are often set as one of the themes. Note that the destination is not limited to the above entertainment facilities, and may include a zoo or a park.

Here, in the present embodiment, the focus will be on costumes used in entertainment facilities, especially cosplay. Cosplay refers to the act of dressing up as a character or characters in manga, anime, or game. Therefore, in cosplay, costumes are an important factor.

Thus, the preferences of a person are reflected by the type of cosplay the person wants to do, the type of costume the person wants to wear, the type of cosplay the person wants to see, the type of cosplayer the person wants to meet, and so on.

Here, in the present application, the wording “want to wear” is not limited to the fact that the person actually wants to wear, and includes the fact that the person wants to see another person wearing the costume and wants to take pictures thereof.

In the present embodiment, matching information is provided to visitors at entertainment facilities (people who wish to visit entertainment facilities), focusing on cosplay described above.

System Configuration

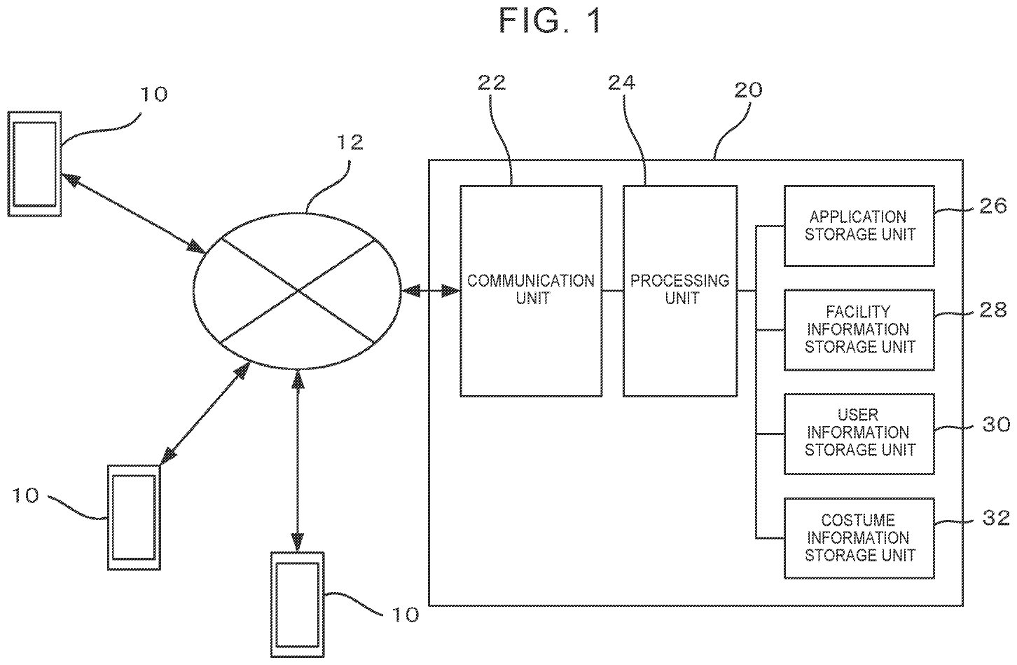

FIG. 1 is a block diagram showing an example of a system that implements the matching information providing method according to the embodiment. In the present embodiment, a plurality of users who wishes to visit an entertainment facility serving as a destination or who visits the entertainment facility has mobile terminals 10 such as smartphones.

The mobile terminals 10 of the users are connected to a communication line 12 such as the Internet via a wireless line or the like. A facility server 20 is connected to the communication line 12. In the present embodiment, the facility server 20 is a server operated by one entertainment facility that the user wishes to visit. The facility server 20 does not have to be located in the entertainment facility as long as the facility server 20 can process data, and may handle a plurality of entertainment facilities. The entertainment facility serves as the destination, but more specifically, the destination is a divided area obtained by dividing the entertainment facility by different concepts.

The facility server 20 is connected to the communication line 12 through a communication unit 22, and the communication unit 22 is connected to a processing unit 24. The facility server 20 is composed of, for example, a general-purpose server computer, and the processing unit 24 performs various kinds of data processing.

An application storage unit 26, a facility information storage unit 28, a user information storage unit 30, and a costume information storage unit 32 are connected to the processing unit 24, and the processing unit 24 controls reading and writing of data with respect to these storage units.

The application storage unit 26 is a unit that stores various application programs, and stores at least a costume application (hereinafter also referred to as “costume app”). The costume app is an app for causing a user to select a costume the user wants to wear and matching users, but the costume app may also be an app that can also perform processing of rental of costumes. Furthermore, an app for applying for admission to an entertainment facility or for applying for a trip including the entertainment facility may be prepared. Alternatively, processing may be selected in one app.

The facility information storage unit 28 stores various kinds of information on the entertainment facility. That is, information on a location, fees, and usage of the entertainment facility, what kind of facilities are available, what attractions are available, and what kind of events are to be held is stored.

The user information storage unit 30 stores information on registered users. For example, first name, last name, age, gender, hobbies, photographs and the like are stored in association with a user ID.

The costume information storage unit 32 stores image data and explanations about character costumes related to the theme in the entertainment facility, that is, costumes of characters of cartoons, movies, and the like. In addition, some character costumes are rented or sold at the entertainment facility. Thus, information on availability and usage of such renting and selling is also stored. Note that such information may be stored as a part of the facility information storage unit 28.

In the present embodiment, the facility server 20 makes a proposal about an accompanying person to the mobile terminal 10. That is, based on the information on the costume of the user that has been provided via the mobile terminal 10, the matching process is performed for the registered users, and information on other users who are recommended to go together is provided to the user who has provided the information on the costume.

Mobile Terminal

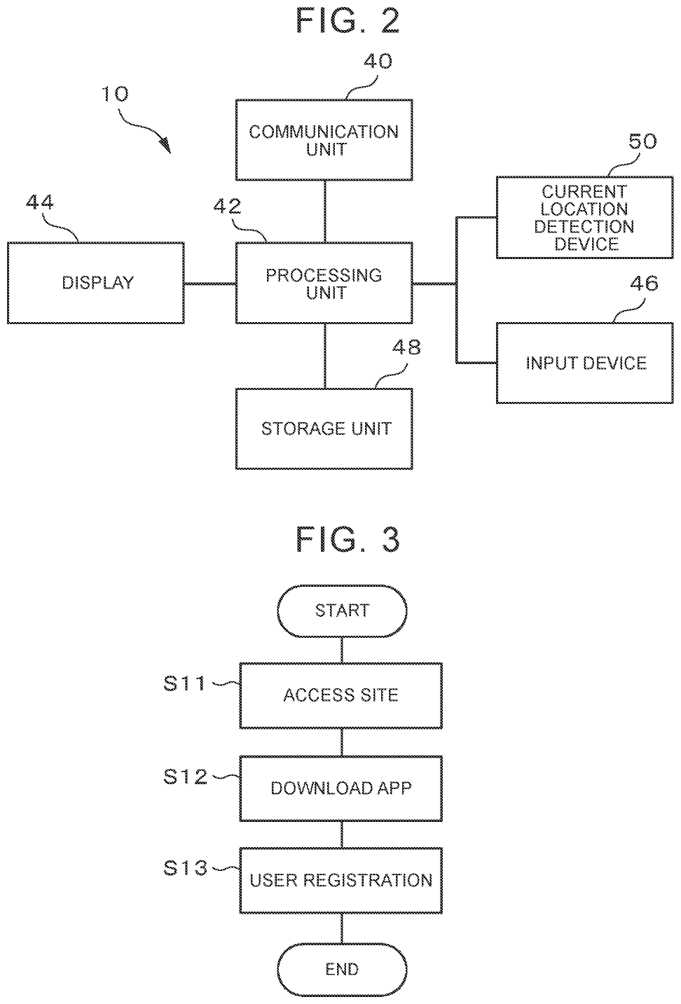

FIG. 2 is a block diagram showing a schematic configuration of the mobile terminal 10. The mobile terminal 10 is an information processing device such as a mobile phone, a smartphone, or a portable computer, that is, a computer.

The communication unit 40 is connected to the communication line 12 and performs processes for various communications. A processing unit 42 is connected to the communication unit 40, and the processing unit 42 performs various kinds of data processing. A display 44 and an input device 46 are connected to the processing unit 42. The input device 46 is, for example, a touch panel, and for the display 44, a liquid crystal display or an organic electroluminescence (EL) display can be adopted. A storage unit 48 is connected to the processing unit 42 and stores various kinds of data. The mobile terminal 10 also includes a current location detection device 50 including Global Navigation Satellite System (GNSS) such as Global Positioning System (GPS) and the like, and can detect the current location.

By operating the mobile terminal 10, the user connects to the facility server 20, transmits necessary data, inputs various kinds of data on the input screen, receives a matching result, and displays the matching result on the display 44.

### User Registration

FIG. 3 is a flowchart illustrating user registration. The user makes a user registration as a pre-process for using the costume app. First, the user connects, using the mobile terminal 10, to an application providing site operated by the facility server 20 (S11). On this site, the user can obtain various kinds of information about the entertainment facility and make various applications, as well as download the costume app. By selecting the download of the costume app, the costume app is downloaded (S12) and installed on the mobile terminal 10.

When the costume app is installed or when the downloaded costume app is started, the mobile terminal 10 is connected to the facility server 20 and a sign-in screen or a user registration screen is displayed. User registration is performed by selecting the user registration and inputting predetermined items (S13).

This user registration is performed by inputting identification data (ID) that identifies an individual, a contact address, gender, date of birth, and the like.

In this example, the costume app is downloaded to the mobile terminal 10 for use, but a configuration may be adopted in which the app is not downloaded and the same processes are performed using an app on the web on a predetermined page of the site on the facility server 20.

Registration about Costumes

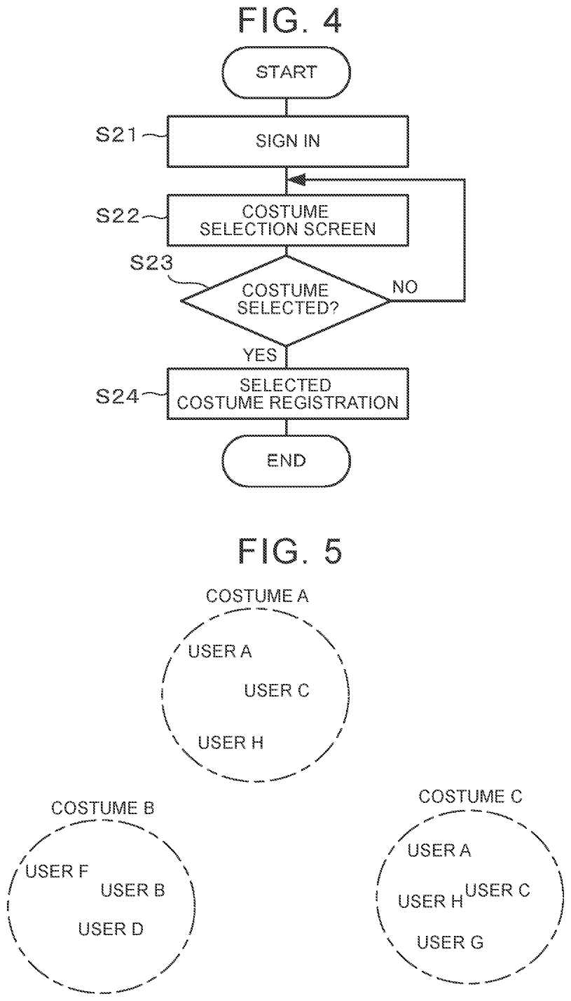

The costume app is used to input preferences for costumes (costumes that the user wants to wear and costumes that the user wants to see other people is wearing). FIG. 4 is a flowchart illustrating costume selection by the user.

First, the user starts the costume app, and selects sign-in to sign in as a registered user (S21). Thereby, a costume selection screen is displayed (S22). Note that a configuration may be adopted in which the user can register to the costume app a unique costume for a character related to the entertainment facility. In this case, the user selects a desired process from a plurality of processes.

The user selects a costume that the user wants to wear on the costume selection screen. The selection of the costume is performed, for example, by selecting a theme and then selecting a character within that theme. After selecting the costume that the user wants to wear (YES in S23), the user registers the selected costume (S24).

In this example, the object is to select a costume that the user likes, but such a process may be performed when the costume is rented. That is, a request for renting the costume may be made through the selection of S23, and matching may be performed for the renting.

Grouping

As described above, when the costume that the user wants to wear is registered, the facility server 20 associates the costume with the user for registration. FIG. 5 shows a state of user registration for each costume. A plurality of users who selects one costume are grouped together. It should be noted that closely related costumes may be grouped together, rather than for one costume. Also, a configuration may be adopted in which points are given to each costume from a number of perspectives and similarity is determined based on the distribution of the points or using artificial intelligence (AI), thereby determining the costumes that are sufficiently similar to each other to have similarity. In addition, groups may be formed by giving a highest priority to the identical costume and ranking the similar costumes in accordance with the degree of similarity. For example, in FIG. 5, a costume A and a costume C have many users who have selected them in common, and such costumes A and C may be recognized as closely related groups.

Such grouping is performed in accordance with the input of each user. Thus, the grouping is performed for a number of users in association with the costumes that the users want to wear.

Matching

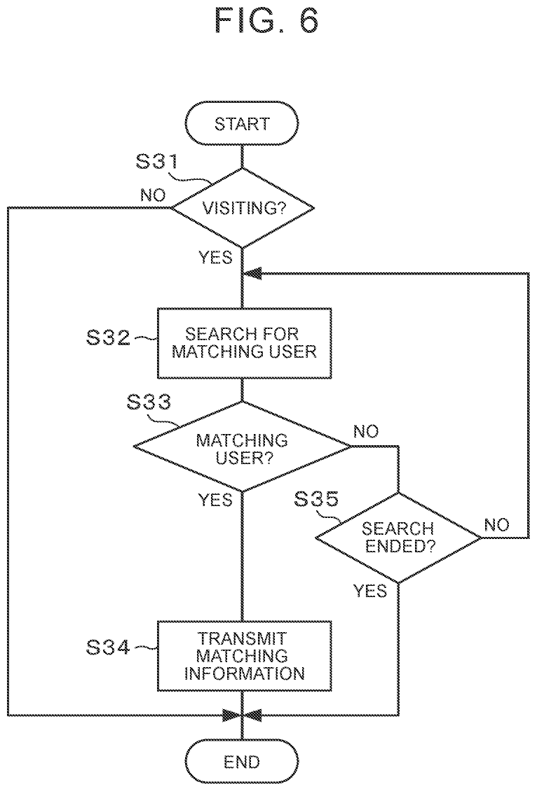

FIG. 6 shows a process of invitation to go together based on the matching result for a visiting user. When a user who has registered a costume that the user wants to wear visits an entertainment facility (YES in S31), the facility server 20 searches for a user who has selected the same costume or a costume with similar tastes based on the registered costume (S32). That is, the facility server 20 determines whether there is another user visiting the entertainment facility, who has selected the costume that the user has selected (S33), and when there is the other user, an invitation to go together is transmitted to both the user and the other user as information of the matching result (S34). In the case of NO in S33, whether the search for other users has been ended is determined (S35). In the case of NO in that determination, the process returns to S32, and in the case of YES, the process ends. Note that the facility server 20 does not necessarily have to provide matching information to both users, and it is sufficient to provide information only to one user and assist in contact between the two users. For example, there may be a request in which a user allows information to be provided to the other user and wants to meet the other user without obtaining the information on the other user.

For example, the facility server 20 issues a notification “there is a person who likes the same costume. Would you like to make contact?” When both users agree, the facility server 20 provides contact information to both users. The users decide a meeting place and go together. The facility server 20 may prompt the users to exchange user information and the like, as necessary. In addition, when the costumes are rented, the costume renting place can be set as a meeting place.

The visit to the entertainment facility (visit information) may be registered to the facility server 20 by the user using the mobile terminal 10. Alternatively, mobile terminal information may be registered for user registration and the facility server 20 may detect the current location information of the mobile terminal 10 as the visit information.

In the above example, the invitation to go together is performed by matching, for the users who are visiting the entertainment facility However, the invitation to go together may be performed before the users actually visit the entertainment facility.

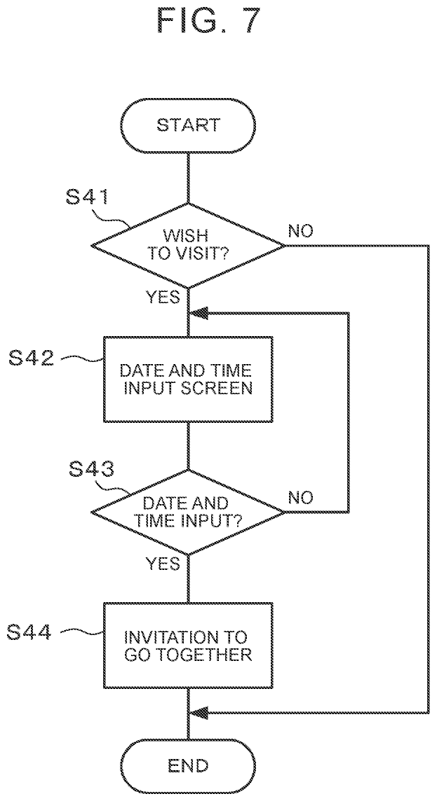

FIG. 7 shows a process of invitation to go together based on the matching result for a user who wishes to visit.

When the user starts the costume app on the mobile terminal 10, the user can select input of the wish to visit. Then, when the input of the wish to visit is selected (YES in S41), a screen for inputting date and time is displayed (S42).

When a desired visiting date (date and time) is input (YES in S43), the visiting date and time are registered in the facility server 20 and the grouping is referred to in the facility server 20 so that whether the same or related costume is selected is searched for users who are going to visit on the overlapping date and time, and when a matching user is found, the search result is provided to the mobile terminals 10 of both users as a matching result and invitation to go together is performed (S44).

After that, when both users agree, the users may decide a meeting spot and a meeting time by direct chatting and the like and meet to go together. Several meeting spots may be determined in advance at the entertainment facility so that the users can select therefrom. Besides, information about objects serving as landmarks for the users may be allowed to be exchanged. In such a process, consent of the user may be obtained as necessary. In addition, whether to go together may be determined after exchange of information on other conditions such as age and gender.

### EFFECT OF EMBODIMENT

As described, according to the present embodiment, another user to invite to go together is determined based on the costume that the user wants to wear. Thus, there is a common topic of costumes, which facilitates matching with a person the user can get along with. Also, when the users act together and actually wear the same costumes, the users can take pictures together and tend to become more close to each other.

Thus, it is possible to provide information of another user that matches the wish of the user.

What is claimed is:

1. A matching information providing method for making a proposal about an accompanying person at a destination, the matching information providing method comprising:
acquiring costume information regarding a costume that a plurality of users wants to wear at the destination, the plurality of users wishing to visit the destination;
grouping users who are determined to match, based on the costume information of the plurality of users; and
providing at least one user, out of the grouped users, with information on another user of the grouped users.

2. The matching information providing method according to claim 1, wherein:
a person wishing to visit downloads a costume application from an application providing site, the costume application allowing selection of the costume the person wants to wear; and
when the costume is selected using the costume application, grouping is performed based on the selected costume.

3. The matching information providing method according to claim 2, further comprising:
acquiring current location information for the plurality of users; and
providing information on the other user of the grouped users for the plurality of users at the destination, the plurality of users being grasped based on the acquired current location information.

4. The matching information providing method according to claim 1, wherein the plurality of users is able to input visit information including a desired date and time of visiting the destination, and the visit information is provided to another user of users grouped by the visit information.

5. The matching information providing method according to claim 1, wherein the costume is a costume for a character related to the destination.

6. A matching information providing program for making a proposal about an accompanying person at a destination, the matching information providing program causing a computer to:
acquire costume information regarding a costume that a plurality of users wants to wear at the destination, the plurality of users wishing to visit the destination;
group users who are determined to match, based on the costume information of the plurality of users; and
provide at least one user, out of the grouped users, with information on another user of the grouped users.
